(19) United States
(12) Patent Application Publication
(10) Pub. No.: US 2024/0053244 A1
(43) Pub. Date: Feb. 15, 2024

(54) MULTI-POINT CAPACITIVE MOTION SENSING STRUCTURE

(71) Applicant: INTERNATIONAL BUSINESS MACHINES CORPORATION, Armonk, NY (US)

(72) Inventors: Frank Robert Libsch, White Plains, NY (US); VENKAT K. BALAGURUSAMY, Airmont, NY (US)

(21) Appl. No.: 17/883,705

(22) Filed: Aug. 9, 2022

(51) Int. Cl. G01N 15/06

(52) U.S. Cl. CPC G01N 15/0656

(57) ABSTRACT

A capacitive probe structure is presented including two or more microfluidic channels defined within a plurality of dielectric layers disposed over a substrate, and a plurality of probes extending through the plurality of dielectric layers such that several probes of the plurality of probes extend to the two or more microfluidic channels to measure at least particle concentrations and particle flow within the two or more microfluidic channels. The plurality of probes are physically and electrically isolated from each other by the plurality of dielectric layers. The plurality of probes further measure a dielectric constant change for conducting and non-conducting liquids and gasses within the two or more microfluidic channels.

### BACKGROUND

The present invention relates generally to electrical capacitive volume tomography, and more specifically, to a multi-point capacitive motion sensing structure.

Detection of the presence, motion and size of droplets or particles in fluidic devices using capacitive sensors/probes is often referred to as electrical capacitance volume tomography. These particles may be large or small such as nanoparticles, viruses, bacteria and other biological organisms. The two most common mechanisms for microdroplet detection are optical sensing and electrical sensing. The majority of devices use microscopes outfitted with high speed cameras. These systems need good optical contrast between the particles being detected and the ambient background fluid. In many cases, a fluorescent tag is attached to the analyte particle to facilitate optical detection overcoming the low contrast in detecting bare analyte particles. Also, besides being large and bulky, and, thus, confined to a laboratory environment (not portable for in-field use), achievable detection resolution is limited in several ways. For example, detection within a 2D image is usually not reliable to detect particles in depth, and submicron size particles that are below the optical diffraction limit, that is 0.5 micron, go undetected.

### SUMMARY

In accordance with an embodiment, a capacitive probe structure is provided. The capacitive probe structure includes two or more microfluidic channels defined within a plurality of dielectric layers disposed over a substrate and a plurality of probes extending through the plurality of dielectric layers such that several probes of the plurality of probes extend to the two or more microfluidic channels to measure at least particle concentrations and particle flow within the two or more microfluidic channels.

In accordance with another embodiment, a capacitive probe structure is provided. The capacitive probe structure includes a first microfluidic channel and a second microfluidic channel defined within a plurality of dielectric layers and a plurality of probes disposed within the plurality of dielectric layers such that at least a first probe of the plurality of probes extends to a sidewall region of the first microfluidic channel and at least a second probe of the plurality of probes extends to a sidewall region of the second microfluidic channel.

In accordance with yet another embodiment, a method for constructing a capacitive probe structure is provided. The method includes forming two or more microfluidic channels within a plurality of dielectric layers and forming a plurality of probes such that several of the plurality of probes extend to sidewalls regions of the two or more microfluidic channels to measure at least particle concentrations and particle flow within the two or more microfluidic channels.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a cross-sectional view of a capacitive probe structure, in accordance with an embodiment of the present invention;

FIG. 2 is a cross-sectional view of a bottom wafer, in accordance with an embodiment of the present invention;

FIG. 3 is a cross-sectional view of the semiconductor structure of FIG. 2 where a first insulating layer is deposited over the bottom wafer, in accordance with an embodiment of the present invention;

FIG. 4 is a cross-sectional view of the semiconductor structure of FIG. 3 where photolithography takes place by deposition of a photoresist layer and a hardmask, in accordance with an embodiment of the present invention;

FIG. 5 is a cross-sectional view of the semiconductor structure of FIG. 4 where in a developing stage the first insulating layer is etched, in accordance with an embodiment of the present invention;

FIG. 6 is a cross-sectional view of the semiconductor structure of FIG. 5 where a first metal via is formed, in accordance with an embodiment of the present invention;

FIG. 7 is a cross-sectional view of the semiconductor structure of FIG. 6 where the first metal via is etched to form a thin metal line, in accordance with an embodiment of the present invention;

FIG. 8 is a cross-sectional view of the semiconductor structure of FIG. 7 where a second insulating layer is deposited, in accordance with an embodiment of the present invention;

FIG. 9 is a cross-sectional view of the semiconductor structure of FIG. 8 where further photolithography takes place by deposition of a photoresist layer and a hardmask, in accordance with an embodiment of the present invention;

FIG. 10 is a cross-sectional view of a semiconductor structure of FIG. 9 where the second insulating layer is etched to form an opening to a top surface of the thin metal line, in accordance with an embodiment of the present invention;

FIG. 11 is a cross-sectional view of the semiconductor structure of FIG. 10 where a second metal via is formed over the thin metal line, in accordance with an embodiment of the present invention;

FIG. 12 is a cross-sectional view of the semiconductor structure of FIG. 11 where the second metal via is etched by chemical mechanical polishing (CMP), in accordance with an embodiment of the present invention;

FIG. 13 is a cross-sectional view of the semiconductor structure of FIG. 12 where a third insulating layer is deposited, in accordance with an embodiment of the present invention;

FIG. 14 is a cross-sectional view of the semiconductor structure of FIG. 13 where further photolithography takes place by deposition of a photoresist layer and a hardmask, in accordance with an embodiment of the present invention;

FIG. 15 is a cross-sectional view of a semiconductor structure of FIG. 14 where the third insulating layer is etched to expose a top section of the second metal via, in accordance with an embodiment of the present invention;

FIG. 16 is a cross-sectional view of the semiconductor structure of FIG. 15 where metal plating takes place to form a third metal portion, in accordance with an embodiment of the present invention;

FIG. 17 is a cross-sectional view of the semiconductor structure of FIG. 16 where the third metal portion is etched by CMP, in accordance with an embodiment of the present invention;

FIG. 18 is a cross-sectional view of the semiconductor structure of FIG. 17 where further photolithography takes place by deposition of a photoresist layer and a hardmask, in accordance with an embodiment of the present invention;

FIG. 19 is a cross-sectional view of the semiconductor structure of FIG. 18 where a first opening or microfluidic channel and a second opening or microfluidic channel are formed to a top surface of the thin metal line to define a sensing channel and a reference channel, in accordance with an embodiment of the present invention;

FIG. 20 is a cross-sectional view of the semiconductor structure of FIG. 19 where a thin metal line, a fourth dielectric layer, a top wafer and a handler are deposited/formed, in accordance with an embodiment of the present invention;

FIG. 21 illustrates the capacitive probe structure and the outer Helmholtz plane potential from the sensing channel of the capacitive probe structure, in accordance with an embodiment of the present invention; and

FIG. 22 is a block/flow diagram of a method for forming the capacitive probe structure including the reference channel and the sensing channel, in accordance with an embodiment of the present invention.

Throughout the drawings, same or similar reference numerals represent the same or similar elements.

### DETAILED DESCRIPTION

Embodiments in accordance with the present invention provide methods and devices for constructing a capacitive probe structure including a first microfluidic channel and a second microfluidic channel. The capacitive probe structure further includes a plurality of probes, at least some of the probes defining a substantially or generally L-shaped configuration such that the probes extend to or within the first and second microfluidic channels. The probes are configured to non-invasively measure at least particle concentrations and/or particle flow.

Electrical sensing provides a scalable, low power, cost-effective, and mobile in-field alternative to optical sensing. Electrical detection of microdroplets can be considered a simpler version of impedance spectroscopy, which uses both resistive and capacitive components to detect signals to retrieve the size of particles, the viability of cells, membrane properties, etc. Presence and size of microdroplets and particles can be detected in a similar manner provided microdroplets or particles have different conductivity and permittivity of the ambient background fluid. Resistive detection limitations arise when the required direct contact sensing electrodes are contaminated by the microdroplets or particles or background fluid, such as oil residue or other higher conductivity particles that limits the smaller conductivity detection of the intended microdroplets or particles. In contrast, capacitive sensing can be performed with passivated electrodes that prevent direct contact with the microdroplets or particles, thus eliminating the possibility of contamination. The exemplary embodiments of the present invention present a capacitive probe structure for alleviating issues presented by conventional systems and methods.

Examples of semiconductor materials that can be used include silicon (Si), germanium (Ge), silicon germanium alloys (SiGe), silicon carbide (SiC), silicon germanium carbide (SiGeC), III-V compound semiconductors and/or II-VI compound semiconductors. III-V compound semiconductors are materials that include at least one element from Group III of the Periodic Table of Elements and at least one element from Group V of the Periodic Table of Elements. II-VI compound semiconductors are materials that include at least one element from Group II of the Periodic Table of Elements and at least one element from Group VI of the Periodic Table of Elements.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

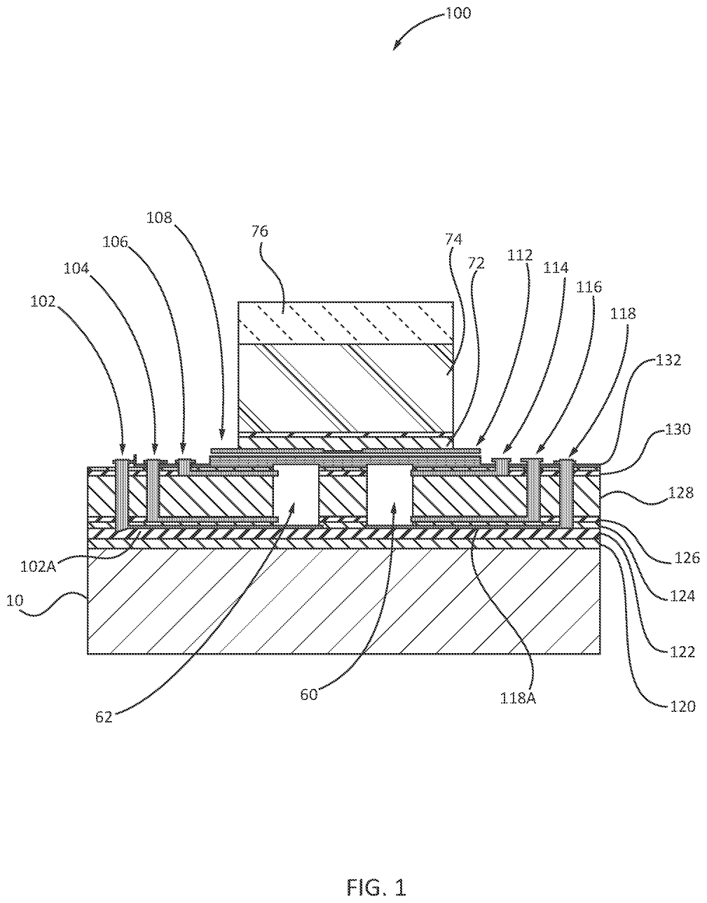

FIG. 1 is a cross-sectional view of a capacitive probe structure, in accordance with an embodiment of the present invention.

The capacitive probe structure 100 includes a plurality of dielectric layers formed over a substrate 10 (or bottom wafer). The plurality of dielectric layers can include, e.g., seven layers, that is, dielectric layers 120, 122, 124, 126, 128, 130, 132. Two microfluidic channels 60, 62 are defined within the plurality of dielectric layers. The first microfluidic channel 60 can be, e.g., a reference channel and the second microfluidic channel 62 can be, e.g., a sensing channel. The two microfluidic channels 60, 62 can have, e.g., a substantially or generally rectangular shape. In one example embodiment, more than two microfluidic channels can be constructed. In another exemplary embodiment, the two or more microfluidic channels can have various shapes, such as circular or oval or even irregular shaped configurations. The microfluidic channels can also be referred to as cavities that are formed to enable holding a gas or a liquid.

A plurality of probes can be constructed within the plurality of dielectric layers. In one instance, eight probes are illustrated, the probes designated as 102, 104, 106, 108, 112, 114, 116, 118. The plurality of probes can also be referred to as a plurality of electrodes.

The first probe 102 extends vertically through several of the plurality of dielectric layers and then extends horizontally into the second microfluidic channel 62. The horizontal portion is designated as 102A. The first probe 102 defines a substantially L-shaped configuration. The second probe 104 also extends vertically through several of the plurality of dielectric layers and then extends horizontally to the second microfluidic channel 62 (e.g., sidewall of the second microfluidic channel 62). The second probe 104 also defines a substantially L-shaped configuration. The third probe 106 also extends vertically through several of the plurality of dielectric layers and then extends horizontally to the second microfluidic channel 62 (e.g., sidewall of the second microfluidic channel 62). The third probe 106 also defines a substantially L-shaped configuration. The fourth probe 108 is generally linear and extends over the second microfluidic channel 62. The first, second, third, and fourth probes 102, 104, 106, 108 are physically and electrically isolated from each other by the plurality of dielectric layers.

The fifth probe 112 is generally linear and extends over the first microfluidic channel 60. The sixth probe 114 extends vertically through several of the plurality of dielectric layers and then extends horizontally to the first microfluidic channel 60 (e.g., sidewall of the first microfluidic channel 60). The sixth probe 114 also defines a substantially L-shaped configuration. The seventh probe 116 extends vertically through several of the plurality of dielectric layers and then extends horizontally to the first microfluidic channel 60 (e.g., sidewall of the first microfluidic channel 60). The seventh probe 116 also defines a substantially L-shaped configuration. The eighth probe 118 extends vertically through several of the plurality of dielectric layers and then extends horizontally into the first microfluidic channel 60. The horizontal portion is designated as 118A. The eighth probe 118 defines a substantially L-shaped configuration. The fifth, sixth, seventh, and eighth probes 112, 114, 116, 118 are physically and electrically isolated from each other by the plurality of dielectric layers.

The plurality of probes 102, 104, 106, 108, 112, 114, 116, 118 non-invasively measure particle concentrations and/or particle flow. The plurality of probes 102, 104, 106, 108, 112, 114, 116, 118 further measure a dielectric constant change for conducting and non-conducting liquids and gasses within the microfluidic channels 60, 62. The plurality of probes 102, 104, 106, 108, 112, 114, 116, 118 are spaced apart (or isolated or separated) from each other so that a voltage drop exists between any two probes.

A dielectric layer 72, a top wafer 74, and a handler 76 can be formed over the two microfluidic channels 60, 62. In one instance, the dielectric layer 72 can directly contact both the fourth probe 108 and the fifth probe 112. The fourth probe 108 and the fifth probe 112 can also directly contact the seventh insulating layer 132. The seventh insulating layer 132 can extend over both the microfluidic channels 60, 62.

In one exemplary embodiment, at least two probes of the plurality of probes extend above the microfluidic channels 60, 62. For instance, the fourth probe 108 and the fifth probe 112 extend over the two microfluidic channels 60, 62.

In another exemplary embodiment, at least four probes of the plurality of probes extend to sidewall regions of the two microfluidic channels 60, 62. For instance, the second probe 104 and the third probe 106 extend to sidewalls of the second microfluidic channel 62, whereas the sixth probe 114 and the seventh probe 116 extend to sidewalls of the first microfluidic channel 60.

In another exemplary embodiment, at least two probes of the plurality of probes extend along a bottom region of the two microfluidic channels 60, 62. For instance, the first probe 102 extends to the bottom region of the second microfluidic channel 62 (via horizontal portion or extension 102A) and the eighth probe 118 extends to the bottom region of the first microfluidic channel 60 (via horizontal portion or extension 118A). The first probe 102 thus extends into the second microfluidic channel 62 and the eighth probe 118 extends into the second microfluidic channel 60. In fact, the first probe 102 thus extends an entire length of the second microfluidic channel 62 and the eighth probe 118 extends an entire length of the first microfluidic channel 60.

In yet another exemplary embodiment, at least two probes of the plurality of probes are generally linear and horizontally aligned with respect to each other. For instance, the fourth probe 108 and the fifth probe 112 are generally linear across their entire length and are horizontally aligned with respect to each other above the two microfluidic channels 60, 62.

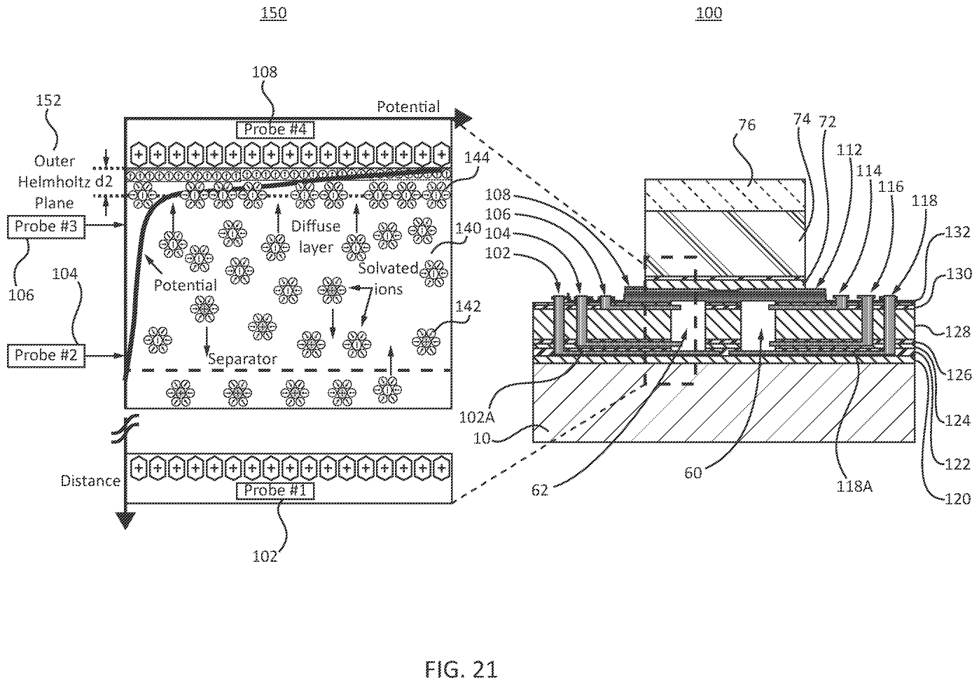

Moreover, it is noted that the capacitive probe structure 100 operates on a microscale and senses a dielectric fluid independent of whether the fluid is in motion or not. In other words, microscopic objects combined with sensitive electronics can be measured by the capacitive probe structure 100. The signals employed can be alternating signals (AC) and steady-state signals (DC). The capacitive probe structure 100 is further designed to correct for the Helmholtz plane, as discussed in detail below with reference to FIG. 21. The capacitive probe structure 100 also incorporates a reference cell providing for the 8-probe structure. The capacitive probe structure 100 can apply to both liquids and gasses. Advantageously, all the probes or electrodes are positioned or placed within a microfluidic cell, where each probe or electrode is a single conductive segment.

FIG. 2 is a cross-sectional view of a bottom wafer or substrate, in accordance with an embodiment of the present invention.

In various example embodiments, a bottom wafer or substrate 10 is formed.

The substrate 10 can be a semiconductor or an insulator with an active surface semiconductor layer. The substrate 10 can be crystalline, semi-crystalline, microcrystalline, or amorphous. The substrate 10 can be essentially (e.g., except for contaminants) a single element (e.g., silicon), primarily (e.g., with doping) of a single element, for example, silicon (Si) or germanium (Ge), or the substrate 10 can include a compound, for example, Al₂O₃, SiO₂, GaAs, SiC, or SiGe. The substrate 10 can also have multiple material layers, for example, a semiconductor-on-insulator substrate (SeOI), a silicon-on-insulator substrate (SOI), germanium-on-insulator substrate (GeOI), or silicon-germanium-on-insulator substrate (SGOI). The substrate 10 can also have other layers forming the substrate 10, including high-k oxides and/or nitrides. In one or more embodiments, the substrate 10 can be a silicon wafer. In an embodiment, the substrate 10 is a single crystal silicon wafer.

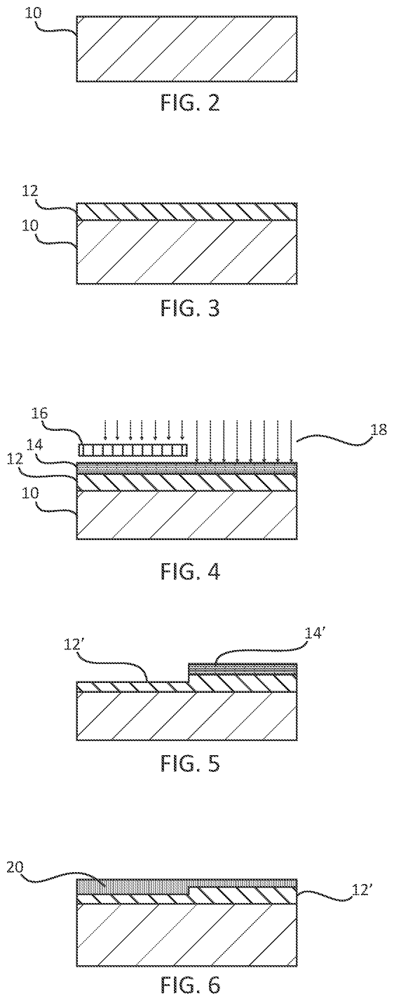

FIG. 3 is a cross-sectional view of the semiconductor structure of FIG. 2 where a first insulating layer is deposited over the bottom wafer, in accordance with an embodiment of the present invention.

In various example embodiments, a first insulating layer 12 is deposited over the bottom wafer 10.

The first insulating layer 12 can be any suitable material, such as, for example, porous silicates, carbon doped oxides, silicon dioxides, silicon nitrides, silicon oxynitrides, or other dielectric materials. Any known manner of forming the first insulating layer 12 can be utilized. The first insulating layer 12 can be formed using, for example, CVD, PECVD, ALD, flowable CVD, spin-on dielectrics, or PVD.

FIG. 4 is a cross-sectional view of the semiconductor structure of FIG. 3 where photolithography takes place by deposition of a photoresist layer and hardmask, in accordance with an embodiment of the present invention.

In various example embodiments, photolithography takes place by deposition of a photoresist layer 14 and a hardmask 16. Radiation 18 is applied to the photoresist layer 14 and the hardmask 16.

The hardmask 16 can be a nitride, for example, a silicon nitride (SiN), an oxynitride, for example, silicon oxynitride (SiON), or a combination thereof.

A photolithography process usually includes applying a layer of photoresist layer 14 (e.g., a material that will react when exposed to light), and then selectively exposing portions of the photoresist layer 14 to light or other ionizing radiation 18 (e.g., ultraviolet, electron beams, X-rays, etc.), thereby changing the solubility of portions of the material. The photoresist layer 14 is then developed by washing the resist with a developer solution, such as, e.g., tetramethylammonium hydroxide (TMAH), thereby removing non-irradiated (in a negative resist) or irradiated (in a positive resist) portions of the resist layer.

FIG. 5 is a cross-sectional view of the semiconductor structure of FIG. 4 where in a developing stage the first insulating layer is etched, in accordance with an embodiment of the present invention.

In various example embodiments, in a developing stage, the first insulating layer 12 is etched to form a remaining first insulating layer 12′. A portion 14′ of the photoresist layer 14 also remains.

The etching can include a dry etching process such as, for example, reactive ion etching, plasma etching, ion etching or laser ablation. The etching can further include a wet chemical etching process in which one or more chemical etchants are used to remove portions of the blanket layers that are not protected by the patterned photoresist.

The dry and wet etching processes can have etching parameters that can be tuned, such as etchants used, etching temperature, etching solution concentration, etching pressure, source power, RF bias voltage, RF bias power, etchant flow rate, and other suitable parameters. Dry etching processes can include a biased plasma etching process that uses a chlorine-based chemistry. Other dry etchant gases can include Tetrafluoromethane (CF₄), nitrogen trifluoride (NF₃), sulfur hexafluoride (SF₆), and helium (He), and Chlorine trifluoride (ClF₃). Dry etching can also be performed anisotropically using such mechanisms as DRIE (deep reactive-ion etching). Chemical vapor etching can be used as a selective etching method, and the etching gas can include hydrogen chloride (HCl), Tetrafluoromethane (CF₄), and gas mixture with hydrogen (H₂). Chemical vapor etching can be performed by CVD with suitable pressure and temperature.

FIG. 6 is a cross-sectional view of the semiconductor structure of FIG. 5 where a first metal via is formed, in accordance with an embodiment of the present invention.

In various example embodiments, a first metal via 20 is formed.

Non-limiting examples of suitable conductive materials for the first metal via 20 include doped polycrystalline or amorphous silicon, germanium, silicon germanium, a metal (e.g., tungsten, titanium, tantalum, ruthenium, zirconium, cobalt, copper, aluminum, lead, platinum, tin, silver, gold), a conducting metallic compound material (e.g., tantalum nitride, titanium nitride, tantalum carbide, titanium carbide, titanium aluminum carbide, tungsten silicide, tungsten nitride, ruthenium oxide, cobalt silicide, nickel silicide), carbon nanotube, conductive carbon, graphene, or any suitable combination of these materials. The conductive material can further include dopants that are incorporated during or after deposition. The conductive metal can be deposited by a suitable deposition process, for example, CVD, PECVD, PVD, plating, thermal or e-beam evaporation, and sputtering.

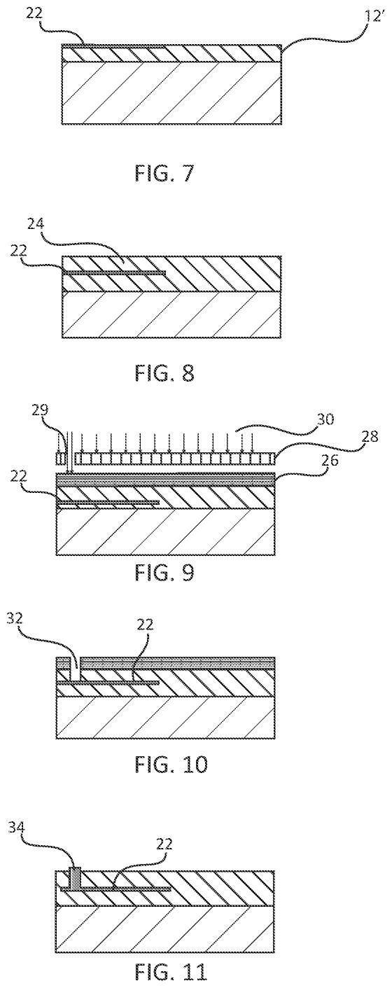

FIG. 7 is a cross-sectional view of the semiconductor structure of FIG. 6 where the first metal via is etched to form a thin metal line, in accordance with an embodiment of the present invention.

In various example embodiments, the first metal via 20 is etched to form a thin metal line 22. The thin metal line 22 extends horizontally over a portion of the remaining first insulating layer 12′. The thin metal line 22 can be, e.g., Cu, Al, Mo, Pt, W, Ta, Ti, Au, Pd or other thin film metals. The thin metal line 22 can be polished by, e.g., chemical mechanical polishing (CMP).

FIG. 8 is a cross-sectional view of the semiconductor structure of FIG. 7 where a second insulating layer is deposited, in accordance with an embodiment of the present invention.

In various example embodiments, a second insulating layer 24 is deposited over the remaining first insulating layer 12′ and the thin metal line 22. The second insulating layer 24 completely surrounds the thin metal line 22. The second insulating layer 24 can be constructed from the same material as the first insulating layer 12. Illustrative dielectrics have been presented above with respect to FIG. 3.

FIG. 9 is a cross-sectional view of the semiconductor structure of FIG. 8 where further photolithography takes place by deposition of a photoresist layer and hardmask, in accordance with an embodiment of the present invention.

In various example embodiments, further photolithography takes place by deposition of a photoresist layer 26 and a hardmask 28, where an opening 29 is formed in the hardmask 28. Radiation 30 is applied to the photoresist layer 26 and the hardmask 28.

FIG. 10 is a cross-sectional view of a semiconductor structure of FIG. 9 where the second insulating layer is etched to form an opening to a top surface of the thin metal line, in accordance with an embodiment of the present invention.

In various example embodiments, the second insulating layer 24 is etched to form an opening 32 to a top surface of the thin metal line 22. The opening extends through the photoresist layer 26. The opening 32 is defined on one end of the thin metal line 22. Stated differently, the opening 32 is defined at a proximal end of the thin metal line 22 toward the edge of the bottom wafer 10.

FIG. 11 is a cross-sectional view of the semiconductor structure of FIG. 10 where a second metal via is formed over the thin metal line, in accordance with an embodiment of the present invention.

In various example embodiments, a second metal via 34 is formed over the thin metal line 22. A portion of the second metal via 34 extends above the second insulating layer 24. The second metal via 34 can be constructed from the same material as the first metal via 20 or the thin metal line 22. Illustrate conductive materials have been presented above with respect to FIG. 6.

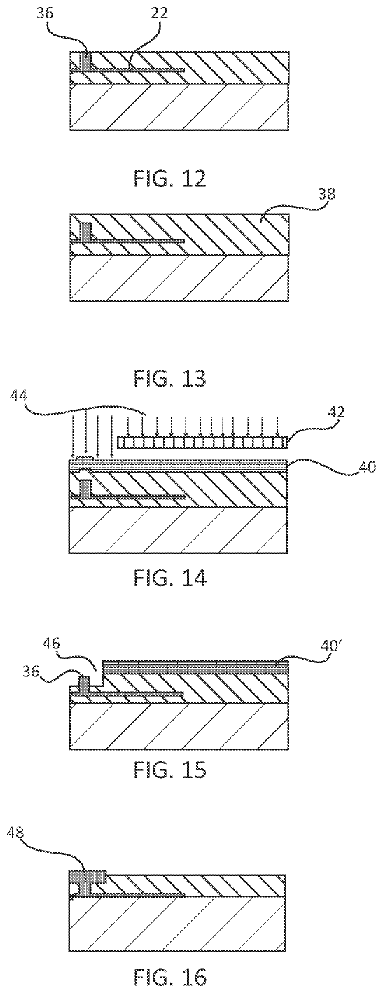

FIG. 12 is a cross-sectional view of the semiconductor structure of FIG. 11 where the second metal via is etched by chemical mechanical polishing (CMP), in accordance with an embodiment of the present invention.

In various example embodiments, the second metal via 34 is etched by chemical mechanical polishing (CMP) to form second metal portion 36. The second metal portion 36 directly contacts the thin metal line 22. The second metal portion 36 and the thin metal line 22 collectively define an L-shaped configuration.

FIG. 13 is a cross-sectional view of the semiconductor structure of FIG. 12 where a third insulating layer is deposited, in accordance with an embodiment of the present invention.

In various example embodiments, a third insulating layer 38 is deposited. The third insulating layer 38 can be constructed from the same material as the first and second insulating layers 12, 24.

FIG. 14 is a cross-sectional view of the semiconductor structure of FIG. 13 where further photolithography takes place by deposition of a photoresist layer and hardmask, in accordance with an embodiment of the present invention.

In various example embodiments, further photolithography takes place by deposition of a photoresist layer 40 and a hardmask 42. Radiation 44 is applied to the photoresist layer 40 and the hardmask 42. The hardmask 42 does not extend over the second metal portion 36. Thus, the proximal end of the structure remains exposed to the radiation 44.

FIG. 15 is a cross-sectional view of a semiconductor structure of FIG. 14 where the third insulating layer is etched to expose a top section of the second metal via, in accordance with an embodiment of the present invention.

In various example embodiments, the third insulating layer 38 is etched by e.g., CMP, to expose, in an opening 46, a top section of the second metal portion 36. Photoresist layer 40′ remains.

FIG. 16 is a cross-sectional view of the semiconductor structure of FIG. 15 where metal plating takes place to form a third metal portion, in accordance with an embodiment of the present invention.

In various example embodiments, metal plating takes place to form a third metal portion 48. The third metal portion 48 can be constructed from the same material as the thin metal line 22 and the second metal portion 36. Illustrate conductive materials have been presented above with respect to FIG. 6. Collectively, the second metal portion 36 and the third metal portion 48 define a substantially or generally T-shaped configuration.

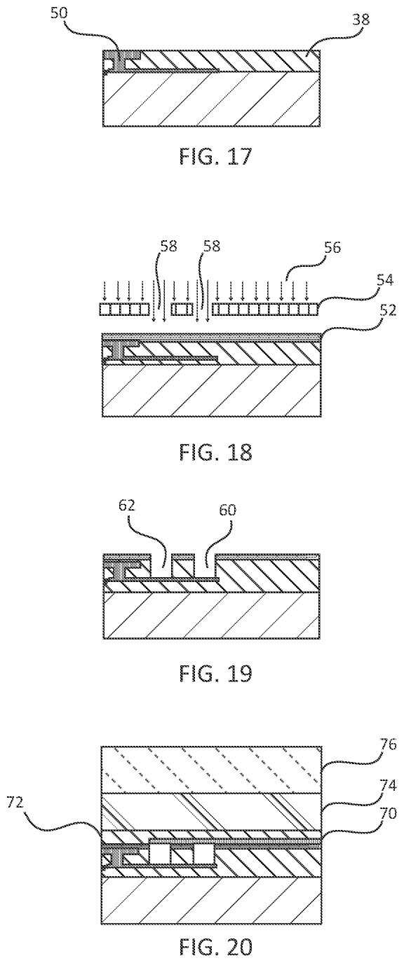

FIG. 17 is a cross-sectional view of the semiconductor structure of FIG. 16 where the third metal portion is etched by CMP, in accordance with an embodiment of the present invention.

In various example embodiments, the third metal portion 48 is etched by, e.g., CMP to form a third metal section 50. Collectively, the second metal portion 36 and the third metal section 50 define a substantially or generally T-shaped configuration.

FIG. 18 is a cross-sectional view of the semiconductor structure of FIG. 17 where further photolithography takes place by deposition of a photoresist layer and hardmask, in accordance with an embodiment of the present invention.

In various example embodiments, further photolithography takes place by deposition of a photoresist layer 52 and a hardmask 54. Radiation 56 is applied to the photoresist layer 52 and the hardmask 54. The hardmask 54 extends over the third metal section 50. In fact, the hardmask 54 includes two openings 58. Both of the openings 58 are vertically aligned with portions of the thin metal line 22. The two openings 58 are constructed to form or define microchannels, as described in FIG. 19.

FIG. 19 is a cross-sectional view of the semiconductor structure of FIG. 18 where a first opening or microfluidic channel and a second opening or microfluidic channel are formed to a top surface of the thin metal line to define a sensing channel and a reference channel, in accordance with an embodiment of the present invention.

In various example embodiments, after developing takes place, a first opening or cavity or microchannel 60 and a second opening or cavity or microchannel 62 are formed to a top surface of the thin metal line 22 to define a sensing channel 62 and a reference channel 60. The openings 60, 62 extend to a top surface of the thin metal line 22. Opening 60 can occupy a same space or area as the opening 62. In one example, openings 60, 62 can be, e.g., substantially or generally rectangular. However, one skilled in the art can contemplate other geometric configurations.

FIG. 20 is a cross-sectional view of the semiconductor structure of FIG. 19 where a handler containing a top wafer with a thin metal line and a fourth dielectric layer, are aligned and bonded to the existing bottom wafer buildup, in accordance with an embodiment of the present invention. The top handler may be removed when it's necessity as a mechanical support is accomplished.

In various example embodiments, a thin metal line 70, a fourth dielectric layer 72, a top wafer 74, and a handler 76 are deposited/formed over the structure. In one instance, a photoresist layer can be positioned between the thin metal line 70 and the third metal section 50.

FIG. 21 illustrates the capacitive probe structure as well as the outer Helmholtz plane potential from the sensing channel of the capacitive probe structure, in accordance with an embodiment of the present invention.

Regarding diagram 150, a Helmholtz layer is a narrow area within an electrolyte 140 that is directly adjacent to an electrode and that carries an excess charge. This is possible if the sum of the charges on the cations 142 is not equal to the sum of the charges on the anions 144 in this area. In the simplest case there are monovalent cations and monovalent anions in different numbers. The Helmholtz layer only includes ions that either lie directly on the electrode without a hydration shell or that are maximally separated from the electrode by a hydration shell. The Helmholtz layer is only a part of the entire electrochemical double layer which, with its diffuse part, can extend far into the electrolyte.

The Helmholtz double layer consists of the aforementioned Helmholtz layer and the oppositely charged layer in the electrode.

The inner Helmholtz plane is a plane parallel to the electrode surface through the centers of gravity of the ions that are directly on the electrode without a hydration shell. Such ions are called specifically adsorbed.

The outer Helmholtz plane is a plane parallel to the electrode surface through the centers of the ions, the hydration shells of which lie directly on the electrode surface, and they are not specifically adsorbed.

Because of the fixed distances between the Helmholtz levels and in contrast to the diffuse part of the double layer, the Helmholtz double layer is also called a rigid double layer. However, that does not mean that the ions do not move. They diffuse both in the plane and in exchange with the diffuse double layer.

The capacitive probe structure 100 is constructed such that it isolates the Helmholtz plane potential from the remaining microfluidic potential. In other words, the capacitive probe structure 100 non-invasively measures at least particle concentrations and/or particle flow, is used in both conductive and non-conductive liquids or gasses, and eliminates the charged Helmholtz layer effect described above.

Moreover, the capacitive probe structure 100 operates in a microscale and senses a dielectric fluid independent of whether the fluid is in motion or not. In other words, microscopic objects combined with sensitive electronics can be measured by the capacitive probe structure 100. The signals employed can be alternating signals (AC) and steady-state signals (DC). The capacitive probe structure 100 is further designed to correct for the Helmholtz plane. The capacitive probe structure 100 also incorporates a reference cell providing for the 8-probe structure. The capacitive probe structure 100 can apply to both liquids and gasses. Advantageously, all the probes or electrodes are positioned or placed within a microfluidic cell, where each probe or electrode is a single conductive segment.

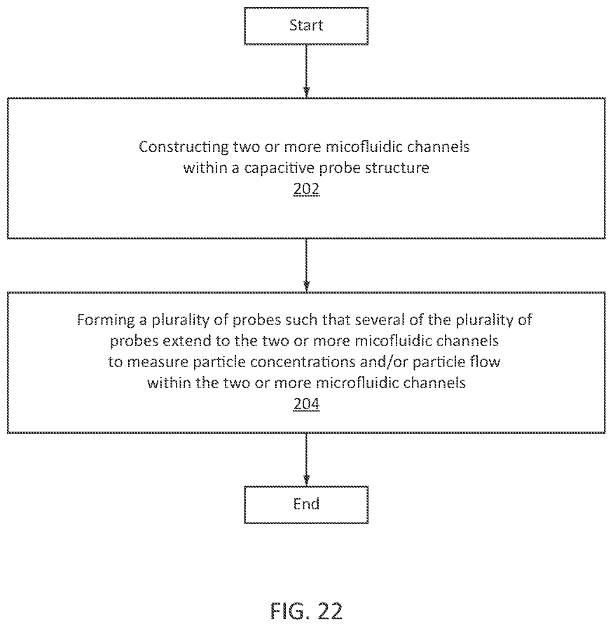

FIG. 22 is a block/flow diagram of a method for forming the capacitive probe structure including the reference channel and the sensing channel, in accordance with an embodiment of the present invention.

At block 202, two or more microfluidic channels are defined or constructed within a plurality of dielectric layers of a capacitive probe structure.

At block 204, a plurality of probes are formed or constructed such that several of the plurality of probes extend to or within the two or more microfluidic channels to measure at least particle concentrations and/or particle flow within the two or more microfluidic channels.

In conclusion, the exemplary embodiments of the present invention introduce methods and devices for constructing a capacitive probe structure including a first microfluidic channel and a second microfluidic channel. The capacitive probe structure further includes a plurality of probes, at least some of the probes defining a substantially or generally L-shaped configuration such that the probes extend to or within the first and second microfluidic channels. The probes non-invasively measure at least particle concentrations and/or particle flow. Moreover, the exemplary capacitive probe structure has a grounded perimeter surrounding all single electrodes, thus eliminating interference from adjacent surfaces. The exemplary capacitive probe structure 100 further enables an identical size reference capacitor, that is, it allows a more sensitive differencing measurement between reference and source, and allows zeroing of all capacitance sources before the actual sample measurement. The exemplary capacitive probe structure 100 employs microelectronic fabrication scaling and uses substantially less sample, is scalable to nanoparticle detection in size and single particle detection in quantity, is real-time and point of detection capable, and eliminates previous capacitor sensor measurement issues with conducting liquids that are complicated by ionic conductivity and the effects of electrode polarization. Finally, the exemplary capacitive probe structure 100 overcomes electrode polarization issues by measuring the voltage drop away from the capacitive plates and thereby avoiding the double (Helmholtz) layer described above.

Regarding FIGS. 1-20, deposition is any process that grows, coats, or otherwise transfers a material onto the wafer. Available technologies include, but are not limited to, thermal oxidation, physical vapor deposition (PVD), chemical vapor deposition (CVD), electrochemical deposition (ECD), molecular beam epitaxy (MBE) and more recently, atomic layer deposition (ALD) among others. As used herein, “depositing” can include any now known or later developed techniques appropriate for the material to be deposited including but not limited to, for example: chemical vapor deposition (CVD), low-pressure CVD (LPCVD), plasma-enhanced CVD (PECVD), semi-atmosphere CVD (SACVD) and high density plasma CVD (HDPCVD), rapid thermal CVD (RTCVD), ultra-high vacuum CVD (UHVCVD), limited reaction processing CVD (LRPCVD), metal-organic CVD (MOCVD), sputtering deposition, ion beam deposition, electron beam deposition, laser assisted deposition, thermal oxidation, thermal nitridation, spin-on methods, physical vapor deposition (PVD), atomic layer deposition (ALD), chemical oxidation, molecular beam epitaxy (MBE), plating, evaporation.

The term “processing” as used herein includes deposition of material or photoresist, patterning, exposure, development, etching, cleaning, stripping, implanting, doping, stressing, layering, and/or removal of the material or photoresist as needed in forming a described structure.

It is to be understood that the present invention will be described in terms of a given illustrative architecture; however, other architectures, structures, substrate materials and process features and steps/blocks can be varied within the scope of the present invention.

It will also be understood that when an element such as a layer, region or substrate is referred to as being “on” or “over” another element, it can be directly on the other element or intervening elements can also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

The present embodiments can include a design for an integrated circuit chip, which can be created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer can transmit the resulting design by physical mechanisms (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which usually include multiple copies of the chip design in question that are to be formed on a wafer. The photolithographic masks are utilized to define areas of the wafer (and/or the layers thereon) to be etched or otherwise processed.

Methods as described herein can be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It should also be understood that material compounds will be described in terms of listed elements, e.g., SiGe. These compounds include different proportions of the elements within the compound, e.g., SiGe includes SiₓGe₁₋ₓ, where x is less than or equal to 1, etc. In addition, other elements can be included in the compound and still function in accordance with the present embodiments. The compounds with additional elements will be referred to herein as alloys.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, such as “beneath,” “below,” “lower,” “above,” “upper,” and the like, can be used herein for ease of description to describe one element's or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the FIGS. is turned over, elements described as “below” or “beneath” other elements or features would then be oriented “above” the other elements or features. Thus, the term “below” can encompass both an orientation of above and below. The device can be otherwise oriented (rotated 90 degrees or at other orientations), and the spatially relative descriptors used herein can be interpreted accordingly. In addition, it will also be understood that when a layer is referred to as being “between” two layers, it can be the only layer between the two layers, or one or more intervening layers can also be present.

It will be understood that, although the terms first, second, etc. can be used herein to describe various elements, these elements should not be limited by these terms. These terms are only used to distinguish one element from another element. Thus, a first element discussed below could be termed a second element without departing from the scope of the present concept.

Having described preferred embodiments of methods and structures providing for a multi-point capacitive motion sensing structure (which are intended to be illustrative and not limiting), it is noted that modifications and variations can be made by persons skilled in the art in light of the above teachings. It is therefore to be understood that changes may be made in the particular embodiments described which are within the scope of the invention as outlined by the appended claims. Having thus described aspects of the invention, with the details and particularity required by the patent laws, what is claimed and desired protected by Letters Patent is set forth in the appended claims.

1. A capacitive probe structure comprising:
two or more microfluidic channels defined within a plurality of dielectric layers disposed over a substrate; and
a plurality of probes extending through the plurality of dielectric layers such that several probes of the plurality of probes extend to the two or more microfluidic channels to measure at least particle concentrations and particle flow within the two or more microfluidic channels.

2. The capacitive probe structure of claim 1, wherein the plurality of probes are physically and electrically isolated from each other by the plurality of dielectric layers.

3. The capacitive probe structure of claim 1, wherein the plurality of probes measure a dielectric constant change for conducting and non-conducting liquids and gasses within the two or more microfluidic channels.

4. The capacitive probe structure of claim 1, wherein the several probes of the plurality of probes that extend to the two or more microfluidic channels have a generally L-shaped configuration.

5. The capacitive probe structure of claim 1, wherein the two or more microfluidic channels include a first channel and a second channel, the first channel being a sensing channel and the second channel being a reference channel.

6. The capacitive probe structure of claim 1, wherein at least two probes of the plurality of probes extend above the two or more microfluidic channels.

7. The capacitive probe structure of claim 1, wherein at least four probes of the plurality of probes extend to sidewall regions of the two or more microfluidic channels.

8. The capacitive probe structure of claim 1, wherein at least two probes of the plurality of probes extend along a bottom region of the two or more microfluidic channels.

9. The capacitive probe structure of claim 1, wherein at least two probes of the plurality of probes are generally linear and horizontally aligned with respect to each other.

10. The capacitive probe structure of claim 1, wherein the two or more microfluidic channels have a generally rectangular shape.

11. The capacitive probe structure of claim 1, wherein the plurality of probes include eight probes and the plurality of dielectric layers include seven dielectric layers.

12. A capacitive probe structure comprising:
a first microfluidic channel and a second microfluidic channel defined within a plurality of dielectric layers; and
a plurality of probes disposed within the plurality of dielectric layers such that at least a first probe of the plurality of probes extends to a sidewall region of the first microfluidic channel and at least a second probe of the plurality of probes extends to a sidewall region of the second microfluidic channel.

13. The capacitive probe structure of claim 12, wherein the plurality of probes are physically and electrically isolated from each other by the plurality of dielectric layers.

14. The capacitive probe structure of claim 12, wherein the plurality of probes measure a dielectric constant change for conducting and non-conducting liquids and gasses within the first and second microfluidic channels.

15. The capacitive probe structure of claim 12, wherein several probes of the plurality of probes that extend to the sidewall region of the first and second microfluidic channels have a generally L-shaped configuration.

16. The capacitive probe structure of claim 12, wherein at least two probes of the plurality of probes extend along bottom regions of the first and second microfluidic channels.

17. The capacitive probe structure of claim 12, wherein at least two probes of the plurality of probes are generally linear and horizontally aligned with respect to each other.

18. The capacitive probe structure of claim 12, wherein the first and second microfluidic channels have a generally rectangular shape.

19. A method for constructing a capacitive probe structure, the method comprising:
forming two or more microfluidic channels within a plurality of dielectric layers; and
forming a plurality of probes such that several of the plurality of probes extend to sidewalls regions of the two or more microfluidic channels to measure at least particle concentrations and particle flow within the two or more microfluidic channels.

20. The method of claim 19, wherein the plurality of probes are physically and electrically isolated from each other by the plurality of dielectric layers.
